(19) United States
(12) Patent Application Publication
(10) Pub. No.: US 2016/0321761 A1
(43) Pub. Date: Nov. 3, 2016

(54) ANALYTICS FOR THE PRESENTATION OF GEMS

(71) Applicant: LinkedIn Corporation, Mountain View, CA (US)

(72) Inventors: Nikita Igorevych Lytkin, Sunnyvale, CA (US); Bee-Chung Chen, San Jose, CA (US); Liang Zhang, Fremont, CA (US)

(21) Appl. No.: 14/698,772

(22) Filed: Apr. 28, 2015

(51) Int. Cl. G06Q 50/00; G06Q 10/10

(52) U.S. Cl. CPC G06Q 50/01; G06Q 10/109

(57) ABSTRACT

A method of generating ranking scores for a combination of a network update and a group of highlight data items associated with the network update is disclosed. Highlight data items generated by one or more first-pass-ranking modules of a gems service are received. The highlight data items are organized into groups. A ranking score for each group is determined. The groups are associated with network updates corresponding to a member of a social networking system. Ranking scores for the network updates are modified based on the association of the groups with the network updates and the ranking score for each group. The groups of highlight data items and the modified ranking scores for the network updates are communicated for use by a client in ranking a combined presentation of the network updates with the groups of highlight data items associated with the network updates.

### TECHNICAL FIELD

The present disclosure generally relates to the technical field of data processing and, in one embodiment, to using a combination of online and offline processes to generate highlight data for presentation in conjunction with update data pertaining to a large number of people in a person's network.

### BACKGROUND

A social network system, such as LinkedIn®, may allow a member to declare or acknowledge relationships (e.g., “connections”) between the member and employers, groups, jobs, and other entities. As the number of these relationships increases, it may become harder for the member to manage them. For example, it may become difficult for the member to follow notifications of the activities of each of the other members or entities, much less determine how to respond to the notifications appropriately, so as to, for example, maintain or strengthen the relationships over time.

### DESCRIPTION OF THE DRAWINGS

Some embodiments are illustrated by way of example and not limitation in the accompanying drawings, in which:

FIG. 1 is a block diagram of the functional modules or components that comprise a computer-network based social network service, including application server modules consistent with some embodiments of the invention;

FIG. 2 is a block diagram depicting some example application server modules of FIG. 1;

FIG. 3 is a block diagram illustrating an example highlight platforms architecture for processing non-batch calls from a client;

FIG. 4 is a block diagram illustrating an example highlight platforms architecture for processing batch calls from a client;

FIG. 5 is a flow diagram illustrating an example method of the gems service processing requests for updates from clients;

FIG. 6A is an example method of continually generating lists of highlights for a viewer according to job schedule;

FIG. 6B is an example method of attaching a pre-generated list of highlights to a response to a request for a network update;

FIG. 7 is an example method of ranking network updates based on ranking scores of groups of highlight data items associated with the network updates;

FIG. 8 is an example method of communicating relationship insights for presentation in a user interface;

FIG. 9 is an example user interface that may be presented in a client application executing on a device of a user in response to receiving network updates including highlight information from the feed mixer;

FIG. 10 is an example user interface that may be presented in a client application executing on a device of a user in response to receiving network updates including highlight information from the feed mixer;

FIG. 11 is an example user interface that may be presented in a client application executing on a device of a user in response to receiving network updates including highlight information from the feed mixer; and

FIG. 12 is a block diagram of a machine in the form of a computing device within which a set of instructions, for causing the machine to perform any one or more of the methodologies discussed herein, may be executed.

### DETAILED DESCRIPTION

The present disclosure describes methods, systems and computer program products for making it easier for a member of a social network system to manage a large number of relationships within the social network system. In the following description, for purposes of explanation, numerous specific details are set forth in order to provide a thorough understanding of the various aspects of different embodiments of the present invention. It will be evident, however, to one skilled in the art, that the present invention may be practiced without all of the specific details and/or with variations permutations and combinations of the various features and elements described herein.

A social network may include edges having multiple dimensions, including, for example, member to member, member to company, member to group, member to school, and member to job edges. A member of the social network may choose to increase the size or density of the social network by performing various actions, including declaring or acknowledging relationships with other members, following companies, joining groups, and applying to jobs. Furthermore, a member may increase a quality or strength of the member's connections by performing various actions, such as making posts, responding to posts of other members (e.g., liking the posts of other members, congratulating another member, or commenting on a post of another member, viewing another member's profile, following another member, following another member, joining a group of other members, and so on), or otherwise interacting with other members. In some embodiments, a profit of an operator of the social network may depend, at least in part, on the size or density of the social network or the strength or quality of the connections included in the social network. Thus, the operator may wish to improve these characteristics of the social network.

In various embodiments, as the size of a member's social network grows, it may be harder for the member to identify relevant actions that will be most beneficial to increasing the size or quality of the member's social network. Members may be more likely to perform relevant actions with respect to the social network as the members become more aware of people to whom they may want to connect, companies they may want to follow, groups they may want to join, and jobs to which they may want to apply. Similarly, members may be more likely to perform relevant actions as they become more aware of how the action may be appropriate in a particular context or beneficial to them.

In various embodiments, a value of the social network that may be hidden from the member (e.g., a “gem”) may be exposed to the member to increase the likelihood that the user will perform a relevant action with respect to the social network.

Gems may be derived for any network edge. In various embodiments, gems may be “relationship insights” or “highlights” derived from a member's social network. For example, for a member to company edge, examples of gems may include any matching information between a member's profile and a target company's profile, connections of the member who work at the company, connections of the member who follow the company, a top number (e.g., 10) connections of the member who have connections working at the company, or a top number of connections of the member who follow the company.

For a member to member edge, examples of gems may include shared connections between a first member and a second member, shared groups between the first member and the second member, shared schools between the first member and the second member, a top number of connections between the first member and the second member (e.g., in terms of network degree), or connections of the first member who worked at one of the second member's employers.

Highlights may include entity highlights (e.g., interesting information included in a profile of a top-level entity, such as a member, influencer, company, job, group, region, skill, or industry), event highlights (e.g., an entity's recent activity or engagement event, such as a recent post or anniversary of the entity), or a network highlight (e.g., facts derived from clustering an entity's network, such as “35% of X's connection work in the software industry and have a masters degree,” where X is a member of the social network, “John extends your network of people who know Hadoop by 15%,” “John's connections increase your network reach into the retail industry in Boston by 35%,” “John knows five more people at Twitter than you.”). Additional examples of gems are described below.

In various embodiments, highlights may be associated with an engagement event. An engagement event may be any event pertaining to a member of the social networking system that invites engagement by other members (e.g., via an action, such as liking an announcement of the event, posting a message in response to the event, sending a private message pertaining to the event, and so on). Examples of engagement events may include a job change, work anniversary, birthday, a person recently met, mentioned in the news, location change, anticipated meeting of a new person, a new meeting connection, and so on. Engagement events are described in more detail below.

In various embodiments, a method of processing engagement event data of a social network system pertaining to a subset of a plurality of members of the social networking system for presentation to an additional member of the social networking system is disclosed. The subset of the plurality of engagement events is selected based on a measure of an importance of each of the subset of the plurality of engagement events to an additional member of the social network transgressing an importance threshold. A relationship insight is determined for each of the subset of the plurality of engagement events based on data items pertaining to the additional member and data items pertaining to each of the subset of the plurality of engagement events. Information pertaining to the subset of the plurality of engagement events and the relationship insight for each of the subset of the plurality of engagement events is communicated for presentation in a user interface of a device of the additional member.

In various embodiments, a method of preparing highlight data for communication to a member of a social networking system in conjunction with network update is disclosed. An offline component is used to repeatedly generate a list of highlights for each of a number of most actively-connected connections of a member of a social network system and store the highlights in a key store. An online component is used to receive a call from a client requesting a network update for the member and attach the generated list of highlights to a response to the request.

In various embodiments, a method of generating ranking scores for a combination of a network update and a group of highlight data items associated with the network update is disclosed. Highlight data items generated by one or more first-pass-ranking modules of a gems service are received. The highlight data items are organized into groups. A ranking score for each group is determined. The groups are associated with network updates corresponding to a member of a social networking system. Ranking scores for the network updates are modified based on the association of the groups with the network updates and the ranking score for each group. The groups of highlight data items and the modified ranking scores for the network updates are communicated for use by a client in ranking a combined presentation of the network updates with the groups of highlight data items associated with the network updates.

Other advantages and aspects of the present inventive subject matter will be readily apparent from the description of the figures that follows.

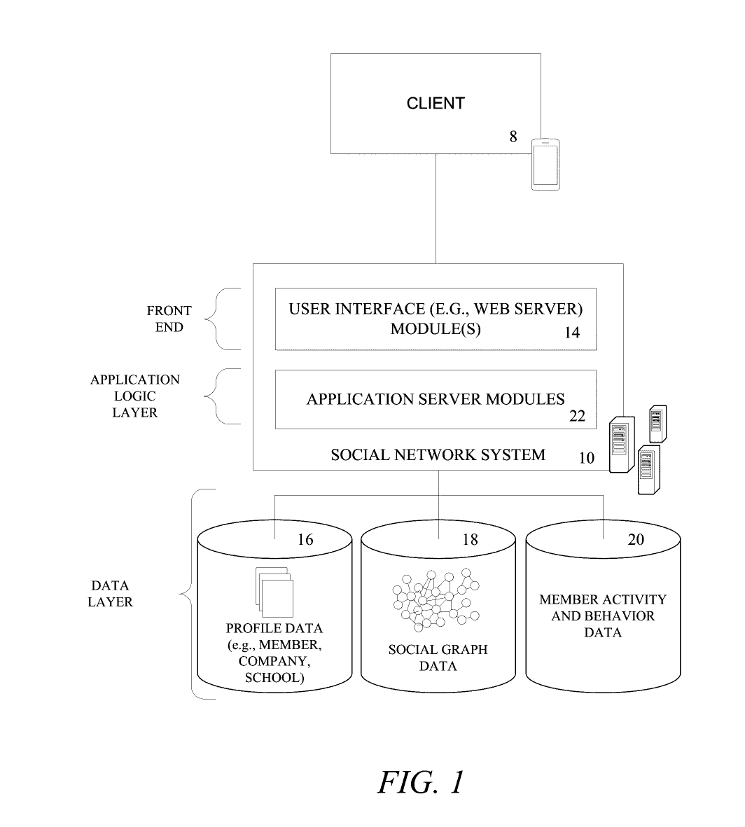

FIG. 1 is a block diagram of the functional modules or components that comprise a computer- or network-based social network service 10 consistent with some embodiments of the invention. As shown in FIG. 1, the social network system 10 is generally based on a three-tiered architecture, comprising a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social network system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such architecture.

As shown in FIG. 1, the front end comprises a user interface module (e.g., a web server) 14, which receives requests from various client-computing devices, and communicates appropriate responses to the requesting client devices. For example, the user interface module(s) 14 may receive requests in the form of Hypertext Transport Protocol (HTTP) requests, or other web-based, application programming interface (API) requests. The client devices (not shown) may be executing conventional web browser applications, or applications that have been developed for a specific platform to include any of a wide variety of mobile devices and operating systems.

As shown in FIG. 1, the data layer includes several databases, including one or more databases 16 for storing data relating to various entities represented in a social graph. With some embodiments, these entities include members, companies, and/or educational institutions, among possible others. Consistent with some embodiments, when a person initially registers to become a member of the social network service, and at various times subsequent to initially registering, the person will be prompted to provide some personal information, such as his or her name, age (e.g., birth date), gender, interests, contact information, home town, address, the names of the member's spouse and/or family members, educational background (e.g., schools, majors, etc.), current job title, job description, industry, employment history, skills, professional organizations, and so on. This information is stored as part of a member's member profile, for example, in the database with reference number 16. With some embodiments, a member's profile data will include not only the explicitly provided data, but also any number of derived or computed member profile attributes and/or characteristics.

Once registered, a member may invite other members, or be invited by other members, to connect via the social network service. A “connection” may require a bi-lateral agreement by the members, such that both members acknowledge the establishment of the connection. Similarly, with some embodiments, a member may elect to “follow” another member. In contrast to establishing a “connection”, the concept of “following” another member typically is a unilateral operation, and at least with some embodiments, does not require acknowledgement or approval by the member that is being followed. When one member follows another, the member who is following may receive automatic notifications about various activities undertaken by the member being followed. In addition to following another member, a user may elect to follow a company, a topic, a conversation, or some other entity. In general, the associations and relationships that a member has with other members and other entities (e.g., companies, schools, etc.) become part of the social graph data maintained in a database 18. With some embodiments a social graph data structure may be implemented with a graph database 18, which is a particular type of database that uses graph structures with nodes, edges, and properties to represent and store data. In this case, the social graph data stored in database 18 reflects the various entities that are part of the social graph, as well as how those entities are related with one another.

With various alternative embodiments, any number of other entities might be included in the social graph, and as such, various other databases may be used to store data corresponding with other entities. For example, although not shown in FIG. 1, consistent with some embodiments, the system may include additional databases for storing information relating to a wide variety of entities, such as information concerning various online or offline groups, job listings or postings, photographs, audio or video files, and so forth.

With some embodiments, the social network service may include one or more activity and/or event tracking modules, which generally detect various user-related activities and/or events, and then store information relating to those activities/events in the database with reference number 20. For example, the tracking modules may identify when a user makes a change to some attribute of his or her member profile, or adds a new attribute. Additionally, a tracking module may detect the interactions that a member has with different types of content. Such information may be used, for example, by one or more recommendation engines to tailor the content presented to a particular member, and generally to tailor the user experience for a particular member.

The application logic layer includes various application server modules 22, which, in conjunction with the user interface module(s) 14, generates various user interfaces (e.g., web pages) with data retrieved from various data sources in the data layer. With some embodiments, individual application server modules 22 are used to implement the functionality associated with various applications, services and features of the social network service. For instance, a messaging application, such as an email application, an instant messaging application, or some hybrid or variation of the two, may be implemented with one or more application server modules 22. Of course, other applications or services may be separately embodied in their own application server modules 22.

The social network service may provide a broad range of applications and services that allow members the opportunity to share and receive information, often customized to the interests of the member. For example, with some embodiments, the social network service may include a photo sharing application that allows members to upload and share photos with other members. As such, at least with some embodiments, a photograph may be a property or entity included within a social graph. With some embodiments, members of a social network service may be able to self-organize into groups, or interest groups, organized around a subject matter or topic of interest. Accordingly, the data for a group may be stored in a database (not shown). When a member joins a group, his or her membership in the group will be reflected in the social graph data stored in the database with reference number 18. With some embodiments, members may subscribe to or join groups affiliated with one or more companies. For instance, with some embodiments, members of the social network service may indicate an affiliation with a company at which they are employed, such that news and events pertaining to the company are automatically communicated to the members. With some embodiments, members may be allowed to subscribe to receive information concerning companies other than the company with which they are employed. Here again, membership in a group, a subscription or following relationship with a company or group, as well as an employment relationship with a company, are all examples of the different types of relationships that may exist between different entities, as defined by the social graph and modelled with the social graph data of the database with reference number 18.

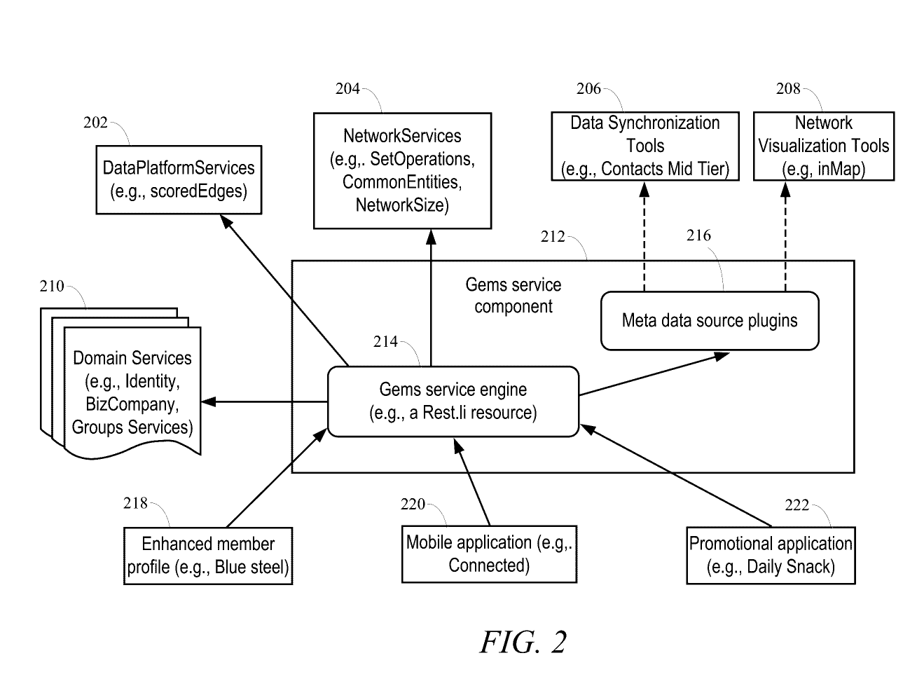

FIG. 2 is a block diagram depicting some example application server modules 22 of FIG. 1. In various embodiments, a central gems service component 212 is responsible for discovering gems, such as relationship insights, from a member's network data. The gems may pertain to any one or more of multiple dimensions of network edges, such as the network edges described above. The central gems service component 212 may encapsulate business logic and serve as a façade for various front-end use cases, which are described in more detail below. The gems service may provide a scalable solution to retrieve information that is context-specific, highly relevant, and powerful, as described in more detail below. In various embodiments, the gems service component 212 may expose an interface that serves stateless requests that have no dependency on other requests (e.g., a Rest.li interface). In various embodiments, the gems service component 212 may have a tracking component (not shown) to facilitate click-through-rate (CTR) data collection, which can then be used to improve existing relevance models or to train a new model. In various embodiments, the gems service component 212 may allow one or more meta data sources to be plugged in (e.g., via meta data source plugin 216) for generating gems that are context specific. Examples of a meta data sources may be data synchronization tools, such as tools for online or offline synchronization of contact, email, and calendar data with member profile data (e.g., LinkedIn synchronization tools or similar), and network visualization tools that allow a member to view their social network data (such as connections) in a visual form (e.g., LinkedIn InMaps or similar), which are described in more detail below.

The gems service component 212 may depend on various downstream services to fulfil a request from a client. Examples of downstream services may include Network Services 204, Data Platform Services 206, Domain Services 210, and meta data source plugins 216.

The Network Services 204 may be configured to provide information pertaining to a relationship between a first member and a second (e.g., target) member. Such information may include information included in member profiles of the first member and second member, including company, group, or school affiliations of the first member and second member. Examples of queries that the gems service may make to the Network Service may include requests for common connections/groups/schools between two members, a member's connections who work at a company or that follow a particular company, a member's connections who have joined a particular group, and a member's connections who have studied at a particular school. Network services may include Graph services, which provide services for identifying a member's network edges, attributes of network edges, graph distances between members, sizes of various degrees of a member's network, common entities between two edge sets, such as common connections, common groups, or common teams, or Pathfinder services, which provide services to allow a member to visualize a connection between the member and any other member via top-level entities, including members, groups, companies, and teams.

The Data Platform Services 202 may be configured to provide information pertaining to the strength of connections of a member. To identify powerful connections of a member, the gems service may query the Data Platform Service for information such as a ranking of the member's connections or returning a top number (e.g., 10) of the ranked connections. The resulting filtered connections may then be used to query the Network Service for additional information about the connections. In various embodiments, the Data Platform Service is configured to provide edge score (e.g., connection strengths), which provide a weight or affinity to edges on a member's social network. The strengths may be based on various factors, including number and kinds of connections, company overlap, school overlap, group overlap, company similarity, functional area similarity, title similarity, industry similarity, and so on.

The Domain Services 210 (e.g., Identity Services, Biz Company Services, Groups Services) may be configured to provide domain-specific information for a given entity, such as a member, company, or group.

The meta data source plug-ins 216 may be configured to provide meta data, such as people a member recently met, people a member is about to meet, and so on. The meta data source may be plugged into the gems service and may include, for example, a calendar event provided by the data synchronization tools 206 plugin or network gems provided by network visualization tools 208. Network gems may include interesting aggregate statistics about a member's network based on known entities, such as companies, region, school, skills, etc. Examples of such network games may include one or a combination of any such statistics, such as a percentage of a member's connections that work at a company, an identification of geographical regions where a percentage of the member's network is located, an identification of a percentage of members having an affiliation to a particular school, a percentage of the member's connections who work in a particular geographical region, a percentage of the member's connection who work in a particular industry, how well the member is connected with people in an industry, how well the member is connected to people knowing or having expertise in a particular technology, a percentage of connections of the member who are following a particular person, and so on. Thus, examples of network gems that may be presented to a viewing member who is viewing information pertaining to a target member X may be: “40% of X's connections work at LinkedIn,” “Most of X's network is located in the San Francisco Bay Area and graduated from Stanford,” “85% of X's connections in New York work in the Finance Industry,” “X is well connected with people in the Internet industry and who know about Hadoop,” “More than a third of X's connections are following Richard Branson on LinkedIn.”

Examples of clients of the gems service component 212 may include an application that presents an enhanced member profile 218, which may add or highlight data pertaining to both the viewer and viewee of the profile (e.g., a Blue steel profile 218), a mobile application 220, such as the Linkedin Connected application, which helps users manage a large number of social networks efficiently, a promotion application 222 (e.g., a Daily Snack application) that generates one or more promotional or advertising messages for communication to a member via a communication channel, such as email).

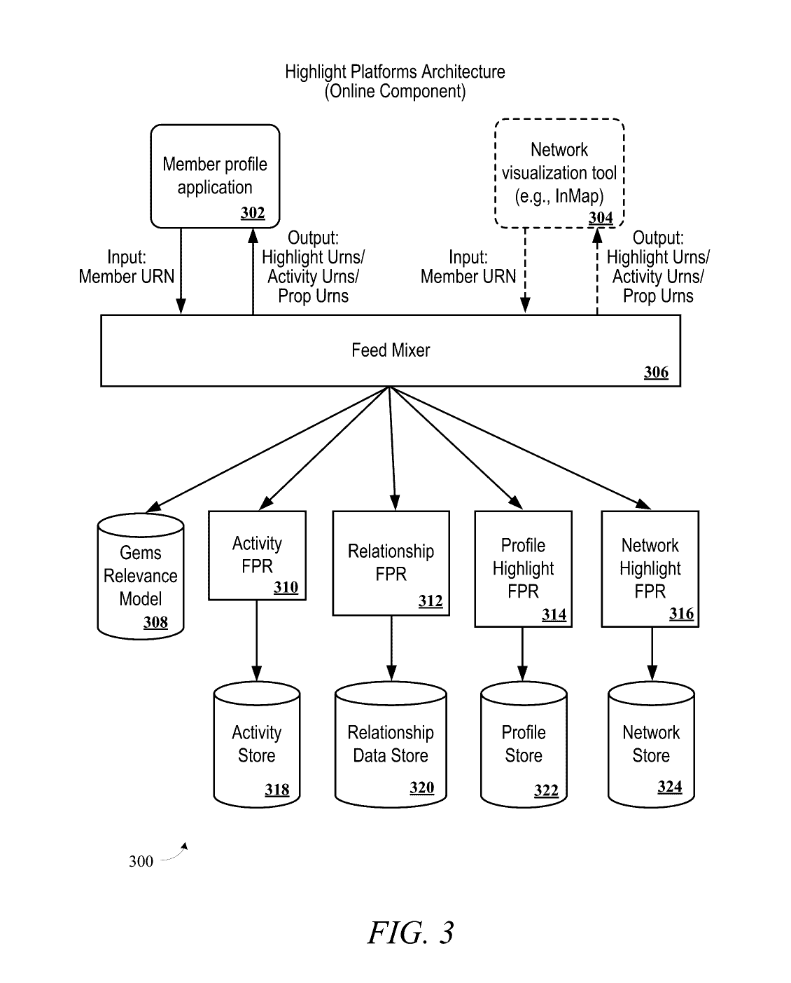

FIG. 3 is a block diagram illustrating an example highlight platforms architecture 300 for processing non-batch calls from a client. In various embodiments, the example highlight platforms architecture 300 processes such non-batch calls using an online component comprising a relationship first pass ranking (FPR) module 312, a profile highlight FPR 314, a network highlight FPR 316, a relationship data store 320, a profile store 322, and a network store 324. In various embodiments, a client, such as a member profile application 302 or an network visualization tool 304 calls an Application Program Interface (API) of the Feed Mixer 306 to retrieve network updates (e.g., news feed content items). The Feed Mixer 360 may then, in turn, call APIs of various highlight first pass ranking (FPR) modules, including an activity FPR 310, the relationship FPR 312, the profile highlight FPR 314, and a network highlight FPR. The gems relevance module 308 may then blend, rank, and output the most relevant, personalized, and engaging output.

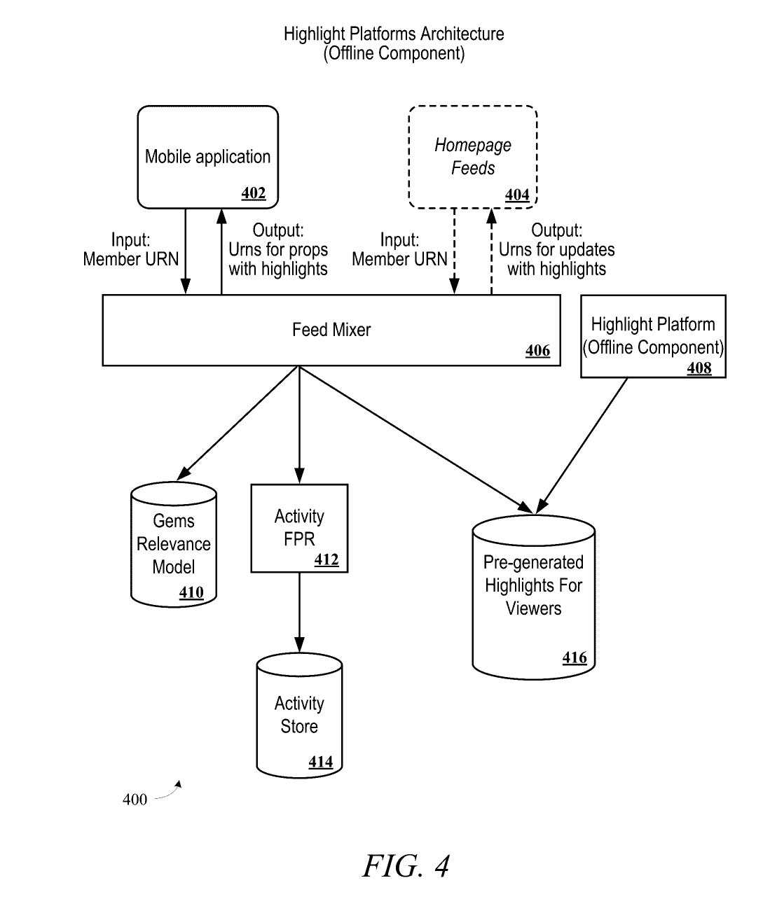

In various embodiments, a client may opt to use the online component instead of an offline component based on an efficiency metric, such as a number of downstream calls that will be generated. Thus, for example, a client that provides the user with gems pertaining to a viewing of another user's member profile may opt to use the online component, whereas a client that provides the user with gems pertaining to multiple updates in the user's news feed may opt to use the offline component (discussed in more detail with respect to FIG. 4).

In various embodiments, the FPR modules 312-316 manage corresponding data stores 320-324. The Relationship Highlight FPR 312 may be configured to rank a member's relationships with other members based on their importance to the member for a particular context or for achieving a particular goal, such as changing a job, changing a career, finding new clients, receiving referrals, researching an industry, and so on.

The Profile Highlight FPR module 314 may be configured to analyze relationship data pertaining to a member's social network. In various embodiments, the Profile Highlight FPR 314 module may be configured to analyze member profiles. The Profile Highlight FPR 314 module may be configured to rank profiles of a set of connections of a member based on similarities between the profile of the member and the profiles of the set of connections of the member.

The Network Highlight FPR module 316 may be configured to cluster data pertaining to a member's social network. For example, the Network Highlight FPR module 316 may be configured to identify similarities between values of data fields corresponding to member profiles of connections of the member. Thus, for example, the Network Highlight FPR module 316 may rank member profiles corresponding to connections of the member based on shared similarities, such as similar educational backgrounds, work histories, and so on.

In various embodiments, the online component may leverage relevance models and a training pipeline provided by other data platforms, such as a data platform comprising a Feed Mixer module 306, an activity FPR module 310 (and the Activity store 318 that it manages), and a Relevance Model module 308. In various embodiments, the Feed Mixer may provide an API that is invoked by one or more clients, such as the member profile application 302 client or the network visualization tool 304, to obtain highlights. For example, when a member views a profile of another member, the member profile application 302 may invoke the API of the Feed Mixer module 306 to obtain information about the viewee. The Feed Mixer 306 may, in turn, invoke the various FPR modules 310-316 to obtain highlights pertaining to the viewee.

In various embodiments, a data schema corresponding to highlights may include a HighlightType, Highlight, Action, entity highlight subtypes, network highlight subtypes, event highlights subtypes, and UseCase schemas.

The HighlightType data schema may be a set of enumerated highlight types. An example enumeration may include a NETWORK_TYPE (e.g., for network highlights), ENTITY_TYPE (e.g., for entity highlights, such as highlights for a member profile), or EVENT_TYPE (e.g., for engagement event highlights). Furthermore, each of the types of highlights may have subtypes, described further below.

The Highlight data schema may include an “id” field. The id field may be of a Uniform Resource Name (URN) type and comprised of a top-level highlight type plus a unique highlight identifier. For example, the id for a highlight may be “urn:li:highlight:<entity>:<id>,” wherein “<entity>” represents the type of the top-level highlight type and “<id>” represents the unique highlight identifier.

In various embodiments, the unique highlight identifier is provided by each FPR module. It may be composed of a hash of the components of the highlight that make it unique. For example, for a profile type highlight having an education info subtype, the unique highlight identifier may be a hash of the viewee identifier, viewer identifier, and EducationInfo data structure. But for a network highlight having a DESCRIPTIVE_SCHOOL subtype, the hash may not include the viewer ID because the network highlight is irrespective of the viewer.

The Highlight data schema may include a “score” field (e.g., of float type) that represents a relevance score assigned to the highlight by the FPR. In various embodiments, the score value may be between 0 and 1. The score may represent a likelihood that a viewer will interact with the highlight (e.g., by opting to perform an action associated with the highlight). The likelihood may be based on analysis of behaviors of members of the social networking system with respect to interactions with similar highlights presented in the past. In various embodiments, the score may be used by clients to do further ranking or classification of the highlight.

The Highlight data schema may include a viewee field that represents the owner of the highlight.

The Highlight data schema may include a viewer field that represents the viewer of the highlight. In various embodiments, the viewee and viewer fields may be of a URN type.

The Highlight data schema may include an effectiveAt field (e.g., of a long type) that is a timestamp representing the effective date of the highlight. In various embodiments, clients may use date differences to refine a relevance score for the highlight.

The Highlight data schema may include a detail field (e.g., of a union type) that maps the highlight to one of the enumerated highlight types.

The Action data schema may represent a suggested action for a given highlight. The Action data schema may include a type field. The type field may specify one of a set of enumerated predefined actions, such as connect, join, send a message (e.g., a predetermined message, such as “great job” or “great experience,” ask a question, like, comment, share, and so on.

The Action data scheme may include a ResourcePath field (e.g., of a string type) that specifies a restli end-point to which a client can make an http post to effect the action.

Examples of entity highlight subtypes that correspond to fields of member profiles may include PROFILE_COMMON_CONNECTIONS (e.g., a list of common connections between a viewer and viewee), PROFILE_COMMON_GROUPS (e.g., a list of common groups between a viewer and viewee, such as corporate, college alumni, non-profit, trade organizations, networking, event, conference, or industry-specific groups), PROFILE_EXPERIENCE (e.g., name of employer, title, location of employment, employment start date, employment end date, start and end dates of employment overlap between viewer and viewee), PROFILE_EDUCATION (e.g., name of school, field of study, degree, start date of school attendance, end date of school attendance, start and end dates of school attendance overlap between a viewer and viewee), PROFILE_LOCATION (e.g., a geographical location of viewee and an indication of whether the geographical location of the viewee overlaps with a geographical location of a viewer, such as during a particular time period), PROFILE_ORGANIZATION_SUPPORTED (e.g., an organization that a viewee has expressed support for or affiliation with and an indication of whether the organization is supported by the viewee as well), PROFILE_TOP_SKILLS (e.g., a list of skills of a viewer, such as professional skills for which a viewer has received endorsements from one or more other members of the social network, and a list of skill overlaps between a viewer and viewee), PROFILE_PROJECT (e.g., a list of titles of projects that a viewer has worked on and an indication of projects that a viewer has in common with a viewee, PROFILE_VOLUNTEERING_CAUSE (e.g., a list of names of causes that a viewee has volunteered to support and a an indication of volunteering causes that the viewer has in common with the viewee).

In various embodiments, profile highlights include an “in common” element between the viewer and viewee. However, profile highlights may also showcase things about the viewer that the viewer does not have in common with the viewee, such as “X has 20 years of experience in the Software Industry,” “X cares about children,” “X has the following top skills: <list of n skills>,” wherein X is the name of the viewee.

Additionally, the entity highlight subtypes may differ based on the types entities involved, such as the type of the viewee (e.g., whether the viewee is a member, company, job, or group).

Examples of network highlights that correspond to categories of network highlights may include DESCRIPTIVE_COMPANY (e.g., “X knows 6 people at DropBox”, DESCRIPTIVE_FUNCTION_COMPANY (e.g., “X knows 15 people in Engineering at Cisco”), DESCRIPTIVE_INDUSTRY (“X knows 25 people in the Media industry”), DESCRIPTIVE_INDUSTRY_REGION (“X knows 10 people in the Media industry in Boston), DESCRIPTIVE_RECENT_INDUSTRY_REGION (“X recently connected with 5 people in the Pharmaceutical industry in New York”), DESCRIPTIVE_INFLUENCER_FOLLOWING (“6 of X's connections are following Bill Gates”), DESCRIPTIVE_RECENT_INFLUENCER_FOLLOWING (“4 of X's connections recently started following Conan O'Brien”), DESCRIPTIVE_REGION (“X knows 13 people in the Los Angeles area), DESCRIPTIVE_SCHOOL (“X knows 25 alumni of MIT”), DESCRIPTIVE_SENIOR_COMPANY (“X knows 3 senior managers at PayPal”), DESCRIPTIVE SKILL (“X knows 45 people who know Hadoop”), DESCRIPTIVE_SKILL_TOP_3 (“Python, Design, and Excel are the top 3 skills in X's network”), DESCRIPTIVE_RECENT_SCHOOL_GRADUATATION (“3 of X's connections are graduating from Stanford University this year.”), DESCRIPTIVE_RECENT_COMPANY_MOVE (“4 of X's connections recently started a position at Google”), COMPARATIVE_CONNECTION (“X recently connected with 3 of your connections”), COMPARATIVE_INDUSTRY (“X has 25% more connections in the Venture Capital industry than you”), COMPARATIVE_GEO (“X adds 25 connections in the Los Angeles area to your network”), COMPARATIVE_COMPANY (“X connects you with 5 new companies in your industry”).

In various embodiments, each network insight may be expressed in a modified form based the type of entity that is the viewee. For example, on a job entity is the viewee, example network insights may include (“X of your connections work in senior positions at this company” or “X of your connections have this job title.”)

Examples of event highlight subtypes may correspond to any of the engagement events described in more detail below.

In various embodiments, the Action associated with a highlight may be selected based at least in part on the type or subtype of the highlight. For example, PROFILE_COMMON_CONNECTIONS may be associated with a Connect action, PROFILE_COMMON_GROUPS may be associated with a Join action, PROFILE_EXPERIENCE may be associated with a “great experience” message action, PROFILE_EDUCATION may be associated with an “ask a question” message action, PROFILE_PROJECT may be associated with a “great job” message action,” DESCRIPTIVE_COMPANY may be associated with one or more of a “view company page,” “add company to profile,” or “see jobs” action, DESCRIPTIVE_INFLUENCER_FOLLOWING may be associated with a “follow influencers” action, DESCRIPTIVE_REGION may be associated with an “update region on profile” or “search region” action, DESCRIPTIVE_SCHOOL may be associated with an “add school to profile” action, DESCRIPTIVE_SKILL may be associated with an “endorse viewee for skill” or “add skill to profile” action, DESCRIPTIVE_SKILL_REPUTATION and DESCRIPTIVE_SKILL_TOP_3 may be associated with an “add skill to profile” action, COMPARATIVE_CONNECTION may be associated with a “view profile” or “request an introduction” action, COMPARATIVE_INDUSTRY may be associated with an “add connections” action, and so on.

The UseCase data schema may include an enumeration of use cases for which the highlights are to be generated. Examples of use cases may include CONNECTED_USE_CASE (e.g., for applications executing on mobile devices), NUS_FEEDS_USE_CASE (e.g., for news feeds accessed a personal computer or tablet), or DEFAULT (e.g., for an unspecified use case).

The Gems Relevance Model module may organize the highlights by type (e.g., entity type, network type, or event type), and assign the collection of highlights a relevance score (e.g., from 0 to 1). The relevance score may be derived from scores assigned to each highlight in the group by the FPR module from which it is received. In various embodiments, the aggregation may be based on weightings assigned to scores received from each of the FPR modules such that scores received from particular FPR modules are counted more heavily in the relevance score that is derived from the aggregation of the scores. In various embodiments, the weightings may be based on use cases (e.g., information pertaining to the client requesting the highlight). In various embodiments, the weightings may differ based on the use case for which the highlights are being prepared. Thus, for example, the CONNECTED_USE_CASE may more heavily weight network highlights, the NUS_USE_CASE may more heavily weight entity highlights, and the DEFAULT use case may randomly merge different highlight types.

FIG. 4 is a block diagram illustrating an example highlight platforms architecture 400 for processing batch calls from a client. In various embodiments, the example highlight platforms architecture processes such batch calls by returning highlights that are pre-generated using an offline component 408. In various embodiments, the example highlight platforms architecture for processing batch calls from a client is the same as the example highlight platforms architecture for processing non-batch calls except that (1) the clients may use resource more efficiently by making batch calls instead of non-batch calls, such as mobile applications (e.g., the LinkedIn Connected application) or homepage feeds instead of clients associated with displaying a member profile or information for visualizing a member's network and (2) the Relationship FPR, Profile Highlight FPR, and Network Highlight FPR modules 314-316 (and their associated data stores 320-324) are replaced with pre-generated highlights for viewer 416, which are managed by the offline component 408.

In various embodiments, the offline component 408 pre-generates highlights 416 for each viewer. The candidate sets of viewees are based on an affinity score between the viewers and viewees. The offline computing may be performed on a schedule (e.g., a daily job). The results may be stored in a key store based on viewer and viewee.

In various embodiments, the feed mixer 406 is enhanced to include the pre-generated highlights 416 into a response to a single request from a client. Thus, the clients need not generate separate requests to the feed mixer 406 for highlights that are the most relevant to each viewer.

In various embodiments, for each viewer, the offline component 408 maintains a computation job (e.g., repeated according to a schedule) that gets the viewer's top N most actively connected connections (e.g., via the feed mixer affinity score). For each member in the list, the offline component 408 generates a list of highlights. The offline component 408 stores the result in a key store keyed by viewer and viewee. Later, when a request to for updates is received from a client at the feed mixer, for each update, the offline component 408 extracts the actor part as the viewee, makes a key of viewer/viewee for looking up highlights related to the update, and attaches the list of highlights to the response to the feed request.

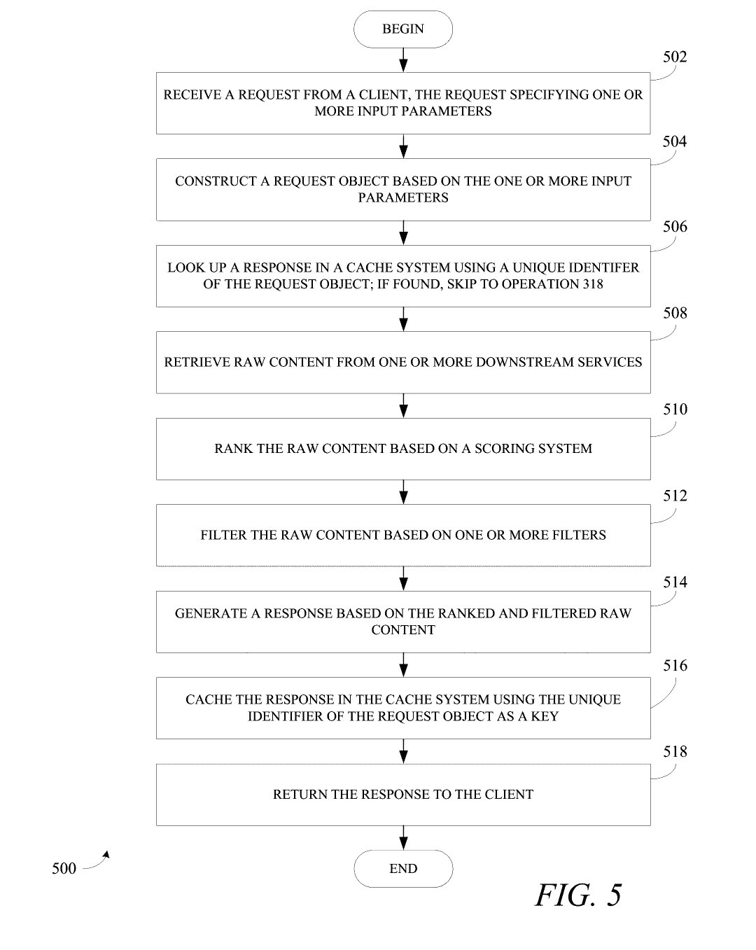

FIG. 5 is a flow diagram illustrating an example method 500 of the gems service processing requests for updates from clients. In various embodiments, the method 500 may be implemented by one or more of the modules of FIGS. 1-4.

At operation 502, the gems service receives a request from a client (e.g., via the feed mixer). In various embodiments, the request may come in the form of a call to an API. The input parameters may include one or more of a viewer, target, action, or action context. The viewer may be a unique identifier for the member of the social network to whom the gems will be presented. The target may be a unique identifier for an entity (e.g., a member, company, group or school). The viewer and target may form a pair, such as a member and member, member and company, or member and group, member and school pair. The action may be a recommended action that the viewer may take with respect to the social network system to, for example, strengthen or broaden the social network of the viewer. Actions may include, for example, view, follow, join, like comment, or congratulation actions. In various embodiments, actions may be related to a particular meta data source, such as an engagement event. An engagement event may be associated with various subtypes, including, for example, a job change, a work anniversary, recently met, about to meet, member publish, location change, or mentioned in news engagement event. The action context may include a map that further describes an action. The map may contain the entity associated with the action. For example, if the action is a “recently met” engagement event, the action context map may contain the calendar event that is the source of the engagement event. The request may be sent as a GET request having a particular format. For example, a request for gems relating to suggesting that a member follow a company may have the form “GET/Gems?viewer=<viewer_identifier>&target=<company_identifier>&action=follow.” As another example, a request for gems relating to suggesting that a first member connect with a second member, the request may have the form “GET/Gems?viewer=<first_member_identifier>&target=<second_member_identifier>&action=conne ct. As another example, a request for gems suggesting that a first member perform an event-specific action with respect to a second member may have the form “GET/Gems?viewer=<first_member_identifier>&action=<event_identifier>&actionContext.activity=<map_identifier>.

At operation 504, the gems service constructs an internal request object based on the input parameters. The request object may have a unique identifier.

At operation 506, the gems service may attempt to look up a response using the internal request object's unique identifier in a distributed cache system. In various embodiments, each member has a dedicated cache.

At operation 508, the gems service retrieves raw content from one or more of the various downstream services (e.g., Network Service, Data Platform Service, Domain services, or meta data sources).

At operation 510, the gems service ranks the raw content using a scoring system.

At operation 512, the gems service may apply one or more filters to the ranked raw content.

At operation 514, the gems services may generate a response based on the ranked and filtered raw content. For example, a response to a request for gems pertaining to an action for a member to follow a company may include one or more ranked and filtered gems, such as any matching information between the member's profile and the company's profile, identification of the member's connections who work at the company, identification of the member's connections who follow the company, the member's top 10 connection who have connections who work at the company, or the member's top 10 connections who follow the company.

As another example, a response to a request for gems pertaining to an action for a first member to connect to a second (target) member may include one or more ranked and filtered gems, such as the target member's current company, position, and duration in current role; a post of an influencer of the target member, a recent activity of the target member, shared connections, groups, schools, employers, and so on, between the first member and the target member; information pertaining to the target member's profile interests; the first member's top 10 connection distance (e.g., in terms of network degree) to the target member.

As another example, a response to a request for gems pertaining to an engagement event involving a first member and a second (target) member may include the target member's new company name and position, the target member's previous company and position, the first member's connections who work at the target member's new company.

In various embodiments, gems may be generated or selected from the raw data based on a type of the engagement event. The gems may be selected based on various factors, such as a strength of a relationship between the first member and the target member, a nature of the type of the engagement event, and so on. Gems for a job change engagement event, for example, may include a new company name and title of the target member, a previous position of the target member, a previous employer of the target member, a duration of employment of the target member at a previous employer, other current positions (e.g., distinguishing between primary job and secondary positions) of the target member, how many connections the first member has at the new company, notes the first member has taken about the target member, and so on.

Gems for a work anniversary engagement event may include, for example, the name of the current company of the target member, the current title of the target member, how many people the first member knows who work at the company of the target member, and so on.

Gems for a birthday engagement event may include, for example, a new company and title of the target member if the target member changed jobs within the last year, personal notes taken by the first member with respect to the private member, profile interests of the target member, and so on.

Gems generated for a “recently met” engagement event may include a title of a meeting in which the first person met the target member, a list of mutual connections of the first member and the target member, profile interests of the target member, and so on.

Gems generated for a “mentioned in the news” engagement event may include, for a example, a title, source, or URL of a news article in which the target member was mentioned.

Gems generated for a “location change” engagement event may include, for example, a new location and an old location of the target member, a list of mutual connections between the first member and the target member that are associated with the new location, and so on.

Gems generated for a “meeting a new person” engagement event may include a current company, title, and duration in current role of the target member, a list of mutual connections between the first member and the target member, a title of a meeting scheduled between the first person and the target member, or profile interests of the target member.

Gems generated for a “meeting connection” engagement event may include a current company, title, and duration in current role of the target member, a list of mutual connections between the first member and the target member, and so on.

At operation 516, the gems service caches the response using the request object as a key in the distributed cache system.

At operation 518, the gems service returns a response to the client.

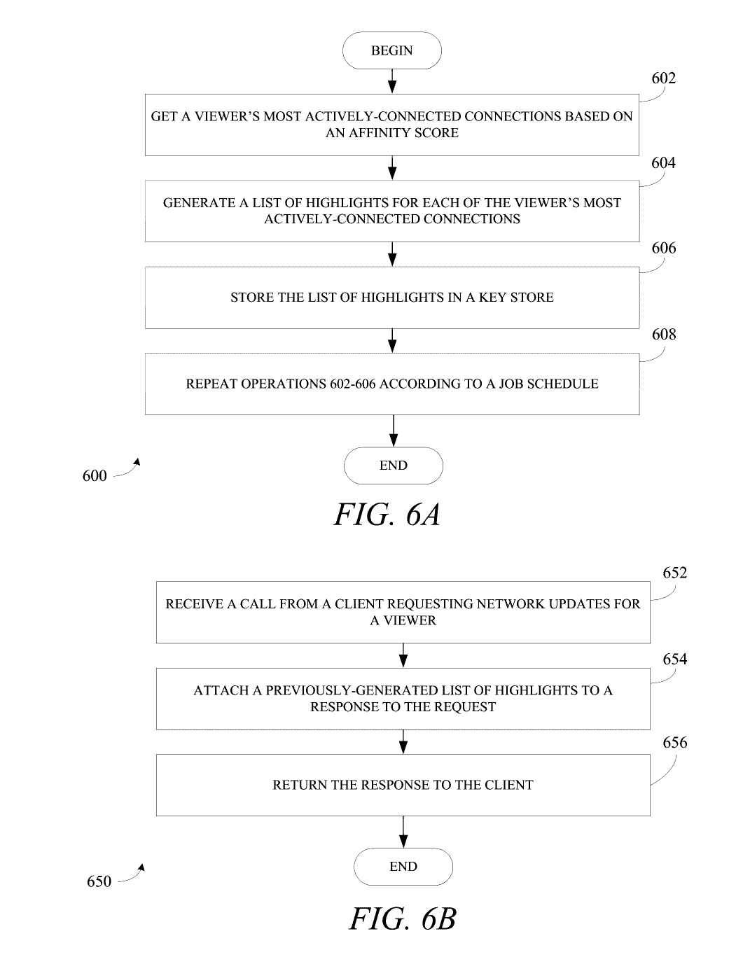

FIG. 6A is an example method 600 of continually generating lists of highlights for a viewer according to job schedule. In various embodiments, the method 600 may be implemented by one or more of the modules of FIGS. 1-4. At operation 602, the offline component gets a viewer's most actively-connected connections based on an affinity score. The affinity score may represent an aggregation of a variety of factors, including a strength of a connection between the viewer and viewee, an importance to the viewer of actions of the viewee, an influence of the viewee, and so on. In various embodiments, the number of the most actively-connected connections is limited (e.g., the top 5 or 10) based on, for example, system resources.

At operation 604, the offline component generates a list of highlights for each of the identified most actively-connected connections. The highlights may be of any type described above.

At operation 606, the offline component stores the list of highlights for each of the most actively-connected connections in a key store (e.g., indexed as a viewer/viewee key).

At operation 608, the offline component repeats operation 602-606 according to a job schedule.

In various embodiments, the offline component performs the example method 600 for all or a subset of all of the members of the social network system. For example, a subset of the members may be selected based on their activity levels with respect to the social network system, such that they are generated for the most active members of the social network system.

FIG. 6B is an example method 650 of attaching a pre-generated list of highlights to a response to a request for a network update. In various embodiments, the method 650 may be implemented by one or more of the modules of FIGS. 1-4. At operation 652, the feed mixer receives a request from a client. The request may request network updates for a particular viewer. The feed mixer may identify one or more network updates corresponding to the request (e.g., via the Activity FPR module). Each update may take a form such as “actor plus verb plus object.” In various embodiments, for each of the network updates, the gems service extracts the actor part of the request as the viewee. Additionally, the gems service makes a viewer/viewee key to look up previously-generated highlights in a key store that correspond to the update based on the actor, verb, and object.

At operation 654, the gems service attaches one or more previously-generated highlights found in the key store to a response to the request. For example, the gems service prepares the highlights for inclusion in a return parameter of an API used by the client to make the request for network updates.

Ata operation 656, the feed mixer sends a response to the request to the client. The response includes the one or more network updates that were requested by the client. Additionally, the response includes the attached set of previously-generated highlights corresponding to each of the network updates. The highlights may also include one or more of ranking scores generated by each of the FPR modules and an aggregate ranking score generated by the gems relevancy module. The highlights may also be organized and ranked by the gems relevancy module such that the client need not rank the results independently. In various embodiments, rea combined activity-highlight ranking algorithm is used in place of the individual scores generated by the FPR modules or the aggregate score generated by the gems relevancy module, as described in more detail below.

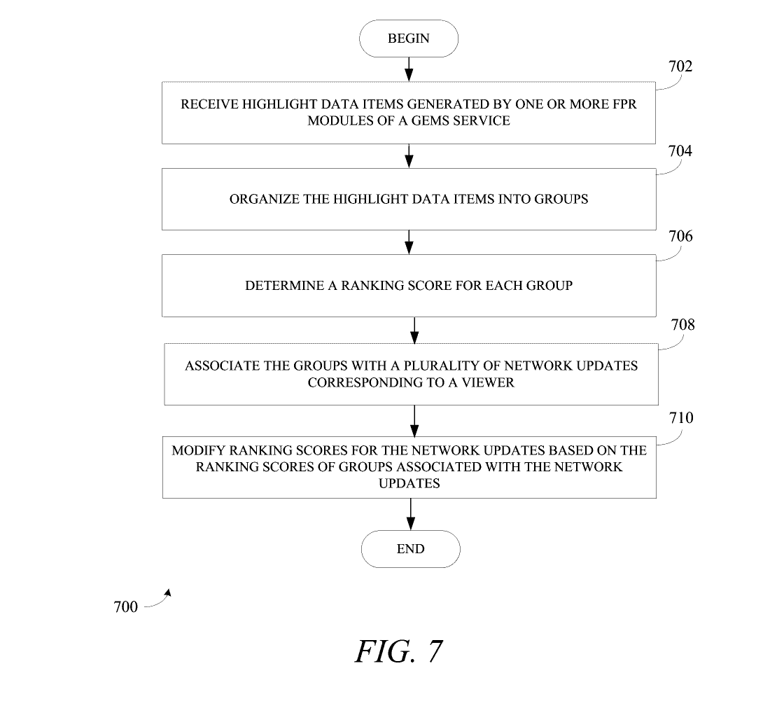

FIG. 7 is an example method 700 of ranking network updates based on ranking scores of groups of highlight data items associated with the network updates. In various embodiments, the method 700 may be implemented by one or more of the modules of FIGS. 1-4. At operation 702, the gems service receives highlight data items generated by one or more FPR modules of a gems service for a viewer associated with an incoming request to the feed mixer for network updates.

At operation 704, the gems service organizes the highlight data items into groups. In various embodiments, the groups are selected based on various factors, such as use case, type of update, or information derived from the highlight data items, such as the actor, verb, and subject of each of the highlights.

At operation 706, the gems service determines a ranking score for each group of highlight data items. The ranking score may be based on individual ranking scores associated with each highlight in the group. The individual rankings scores may be generated by the FPR modules. Additionally, the individual ranking scores may be weighted by the gems service, as described above.

At operation 708, the groups of highlight data items may be associated with network updates corresponding to the viewer. For example, a group of highlight data items pertaining to a particular viewee may be associated with a network update pertaining to that viewee.

At operation 710, the feed mixer modifies a ranking score corresponding to the network update based on the ranking score for the group of highlight data items associated with the network update. Thus, a ranked list of network updates may be returned to a client that not only considers the importance of the update itself, but also the highlight data items that have been grouped and associated with the network update by the gems service.

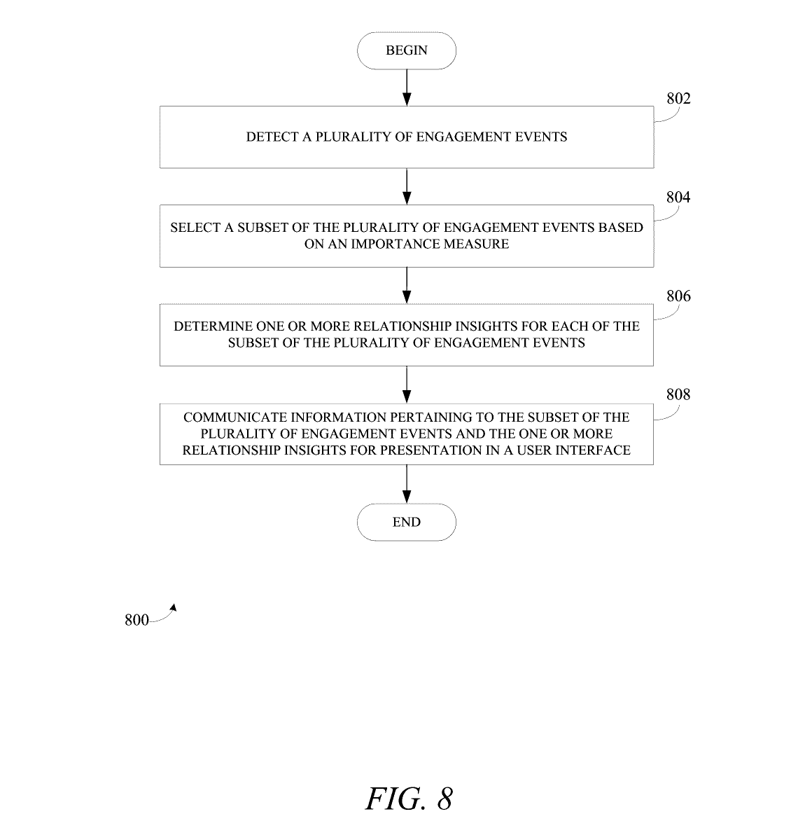

FIG. 8 is an example method 800 of communicating relationship insights for presentation in a user interface. In various embodiments, the method 800 may be implemented by one or more of the modules of FIGS. 1-4. At operation 802, a plurality of engagement events pertaining to a subset of a plurality of members having a relationship with an additional member of a social network is determined.

At operation 804, a subset of the plurality of engagement events is selected based on an importance of each of the subset of the plurality of engagement events to the additional member transgressing an importance threshold.

At operation 806, a relationship insight is determined for each of the subset of the plurality of engagement events based on network highlights generated for the engagement events. For example, the gems service may process the actor-verb-subject of each of the highlights generated for the engagement event to determine a relationship insight.

At operation 808, information pertaining to the subset of the plurality of engagement events and the different relationship insights corresponding to each of the plurality of engagement events are communicated for presentation in a user interface of an application executing on a client device of the user.

Thus, for example, a user of an application executing on a mobile device may receive relationship insights pertaining to selected subjects of the engagement events such that the user may tailor an action that the user may perform with respect to the social network system (e.g., sending a message to a subject of the engagement event) such that the user may strengthen his relationship with the subject of the engagement event with a minimal amount of effort.

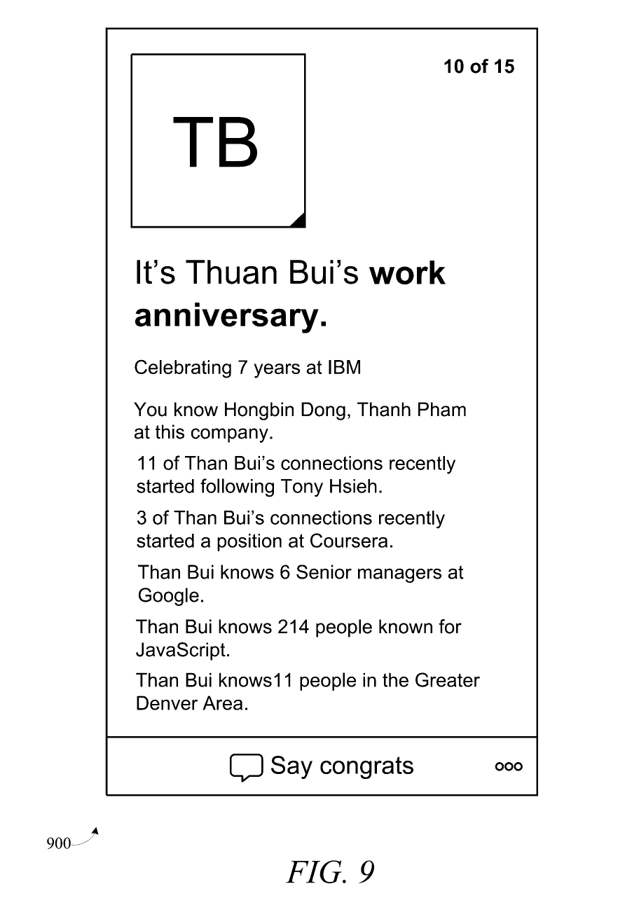

FIG. 9 is an example user interface 900 that may be presented in a client application executing on a device of a user in response to receiving network updates including highlight information from the feed mixer. The user interface 900 includes information pertaining to an engagement event (e.g., a work anniversary event) for a subject of the engagement event (e.g., Than Bui). This particular engagement event may have been selected from a plurality of such engagement events in the user's social network for presentation to the user based on various factors, such as an affinity score between the user and the subject of the engagement event. The user interface includes a profile highlight corresponding to the subject of the profile of the engagement event (“Celebrating 7 years at IBM”). This profile highlight may have been selected for the user based on any of the ranking algorithms discussed above. The user interface 900 includes a network highlight (“You know Hongbin Dong, Thanh Pham at this company.”). This network highlight may also have been selected for the user based on any of the ranking algorithms discussed above.

The user interface includes a user interface element (e.g., a “Say congrats” link) that allows the user to take an action with respect to the subject of the engagement event. Here, the user may simply click on the user interface element to acknowledge the engagement event. The action may have been selected for the user based on a likelihood that the user would perform the action. Furthermore, the congratulations message may be customized to include data items derived from the network highlight, such that the message includes content that turns the message into more than just a generic congratulations message—for example, an automatically-generated message for this engagement event might be “Congratulations, Than, for surviving for 7 years at IBM. If you know my connections Hongbin or Thanh, who also work at IBM, please share your secrets with them!” Upon clicking the Action button, the user may automatically send such a pre-generated message or be presented with an option to customize the message before sending it.

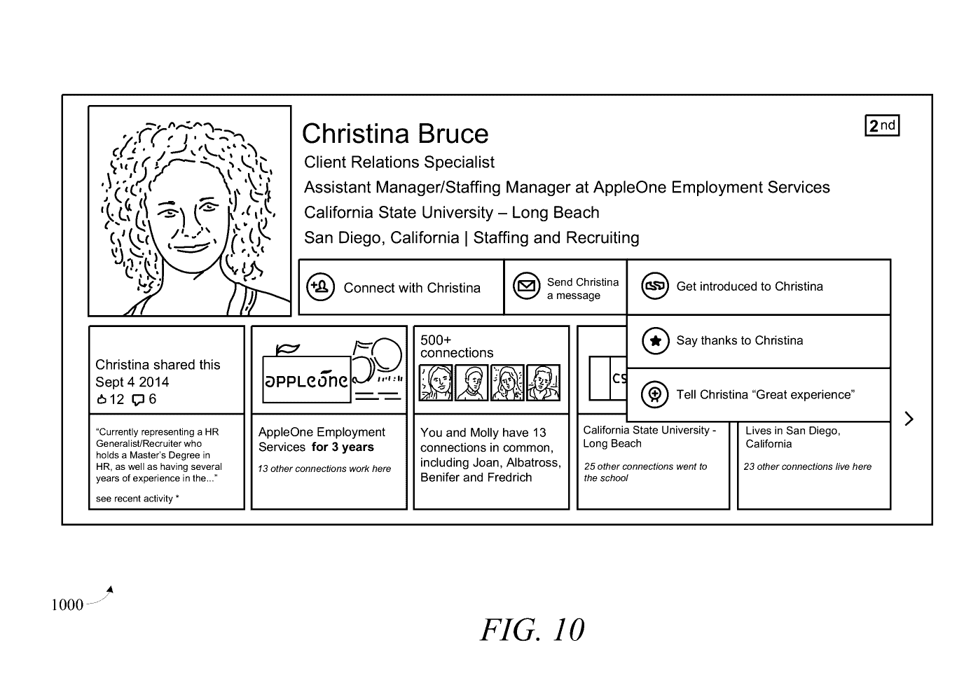

FIG. 10 is an example user interface 1000 that may be presented in a client application executing on a device of a user in response to receiving network updates including highlight information from the feed mixer. The user interface 1000 may be presented in response to a user browsing a profile of a particular member of the social networking system. The user interface 1000 includes a summary of profile information corresponding to the member, including the member's name and information about the member's job titles, education, location and industry. The user interface includes activity information (e.g., a post that the user shared on a particular date). In various embodiments, the activity information may be selected from a plurality of activities performed by the user based on an activity ranking algorithm, as described above. The user interface 1000 includes various highlights, including entity and network highlights, such as (1) how many years the member has been employed at her current employer and how many connections of the viewer work at that employer, (2) a number of connections of the member and how many connections the viewer has in common with the member, (3) a university that the member attended and how many other connections of the viewer attended that university, and (4) a location of the member and how many connections of the viewer are also at the location. The user interface also includes a set of actions that a viewer may perform with respect to the member. The actions may be selected based on various criteria, as described above.

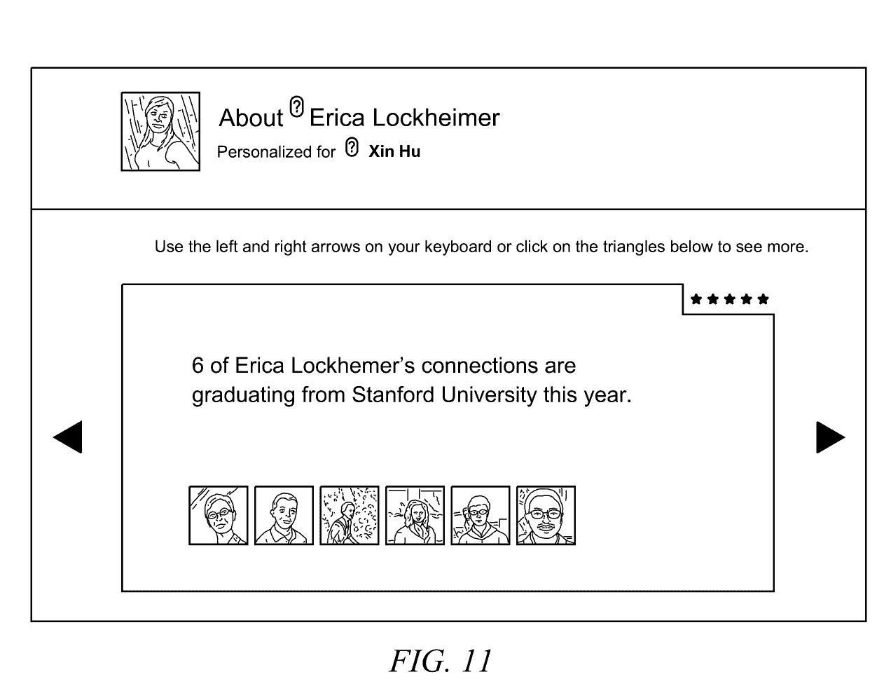

FIG. 11 is an example user interface 1100 that may be presented in a client application executing on a device of a user in response to receiving network updates including highlight information from the feed mixer. The user interface 1000 may be presented to the user upon an accessing of the client application by the user. The user interface 1000 includes a summary of a network highlight corresponding to a selected on of a user's connections on a social networking system. The connection may be selected based an affinity score. Additionally, the highlight may be selected based on a ranking score. Or, in various embodiments, a combined ranking score may be used to take into account the ranking of the highlight as well as the affinity score. In various embodiments, the user interface may be presented to the user on a mobile device. The highlights presented in the user interface may be limited to only the top highlights. Additionally, the members who are the subjects of the highlights may be only the top members (e.g., a subset of the most actively-connected members to the viewer). Thus, in such a mobile application, a user may efficiently navigate through only the most important highlights in the user's social network and be given an option to perform an appropriate action in response to notification of each of the highlights so as to strengthen the user's relationships in the social network.

The various operations of the example methods described herein may be performed, at least partially, by one or more processors that are temporarily configured (e.g., by software instructions) or permanently configured to perform the relevant operations. Whether temporarily or permanently configured, such processors may constitute processor-implemented modules or objects that operate to perform one or more operations or functions. The modules and objects referred to herein may, in some example embodiments, comprise processor-implemented modules and/or objects.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

The one or more processors may also operate to support performance of the relevant operations in a “cloud computing” environment or within the context of“software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

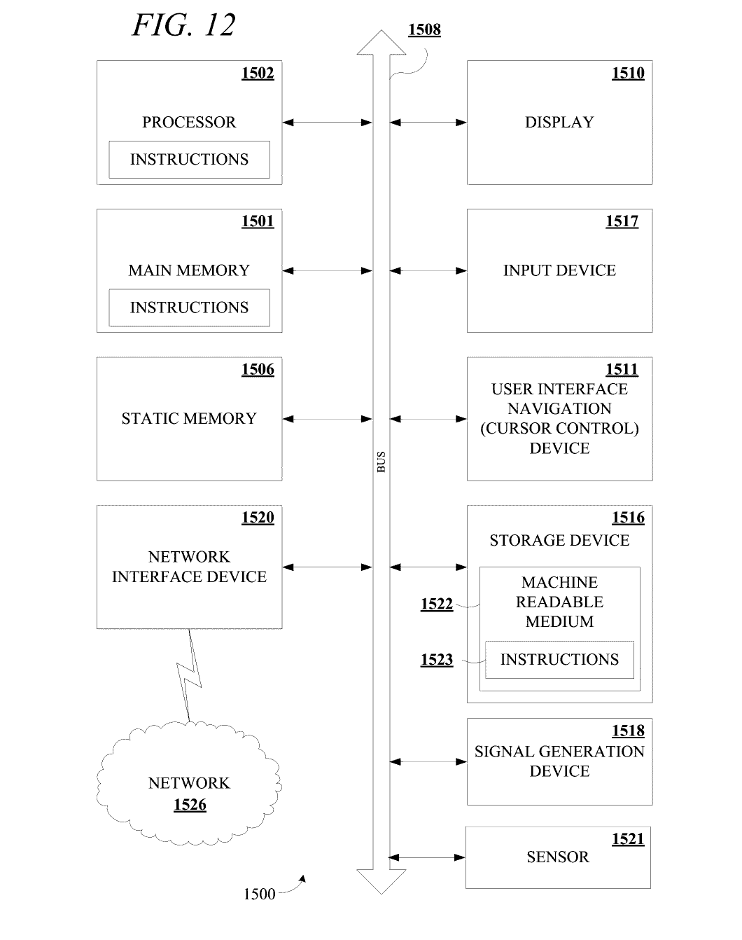

FIG. 12 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device 1516 (e.g., drive unit), a signal generation device 1518 (e.g., a speaker), a network interface device 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software 1523) embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1523 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fii and WiMax) networks). The term “transmission medium” shall be taken to include any intangible medium that is capable of storing, encoding or carrying instructions for execution by the machine, and includes digital or analog communications signals or other intangible medium to facilitate communication of such software.

Although embodiments have been described with reference to specific examples, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A method comprising:
receiving highlight data items generated by one or more first-pass-ranking modules of a gems service;
organizing the highlight data items into groups;
determining a ranking score for each group;
associating the groups with network updates corresponding to a member of a social networking system;
modifying ranking scores for the network updates based on the association of the groups with the network updates and the ranking score for each group; and
communicating the groups of highlight data items and the modified ranking scores for the network updates for use by a client in ranking a combined presentation of the network updates with the groups of highlight data items associated with the network updates.

2. The method of claim 1, wherein the organizing of the highlight data items into groups is based on at least one of an actor, verb, and subject derived from each of the highlight data items.

3. The method of claim 2, wherein the associating of the groups with the network updates is based on at least one of an actor, verb, and subject derived from each of the network updates.

4. The method of claim 1, wherein the ranking scores of the network updates are based on an affinity score between the member and a combination of the actors and subjects derived from each of the network updates.

5. The method of claim 1, further comprising weighting the ranking score for each group based on a use case for which the ranking scores for the network updates are being generated.

6. The method of claim 1, wherein each of the highlight data items includes contextual data that the member can incorporate into an action performed in response to the corresponding network update.

7. The method of claim 6, wherein the contextual data includes information pertaining to a commonality between the member and a subject of the network update.

8. A system comprising:
one or more modules implemented by one or more processors, the one or more modules configured to, at least:
receive highlight data items generated by one or more first-pass-ranking modules of a gems service;
organize the highlight data items into groups;
determine a ranking score for each group;
associate the groups with network updates corresponding to a member of a social networking system; and
modify ranking scores for the network updates based on the association of the groups with the network updates and the ranking score for each group.

9. The system of claim 8, wherein the organizing of the highlight data items into groups is based on at least one of an actor, verb, and subject derived from each of the highlight data items.

10. The system of claim 9, wherein the associating of the groups with the network updates is based on at least one of an actor, verb, and subject derived from each of the network updates.

11. The system of claim 8, wherein the ranking scores of the network updates are based on an affinity score between the member and a combination of the actors and subjects derived from each of the network updates.

12. The system of claim 8, the one or more modules further configured to weight the ranking score for each group based on a use case for which the ranking scores for the network updates are being generated.

13. The system of claim 8, wherein each of the highlight data items includes contextual data that the member can incorporate into an action performed in response to the corresponding network update.

14. The system of claim 13, wherein the contextual data includes information pertaining to a commonality between the member and a subject of the network update.

15. A non-transitory computer-readable storage medium storing instructions thereon, which, when executed by one or more processors, cause the one or more processors to perform operations, the operations comprising:
receiving highlight data items generated by one or more first-pass-ranking modules of a gems service;
organizing the highlight data items into groups;
determining a ranking score for each group;
associating the groups with network updates corresponding to a member of a social networking system; and
modifying ranking scores for the network updates based on the association of the groups with the network updates and the ranking score for each group.

16. The non-transitory computer-readable storage medium of claim 15, wherein the organizing of the highlight data items into groups is based on at least one of an actor, verb, and subject derived from each of the highlight data items.

17. The non-transitory computer-readable storage medium of claim 16, wherein the associating of the groups with the network updates is based on at least one of an actor, verb, and subject derived from each of the network updates.

18. The non-transitory computer-readable storage medium of claim 15, wherein the ranking scores of the network updates are based on an affinity score between the member and a combination of the actors and subjects derived from each of the network updates.

19. The non-transitory computer-readable storage medium of claim 15, further comprising weighting the ranking score for each group based on a use case for which the ranking scores for the network updates are being generated.

20. The non-transitory computer-readable storage medium of claim 15, wherein each of the highlight data items includes contextual data that the member can incorporate into an action performed in response to the corresponding network update.
